(19) United States
(12) Patent Application Publication
(10) Pub. No.: US 2001/0018656 A1
(43) Pub. Date: Aug. 30, 2001

(54) Method and server for setting up a communication connection via an IP network

(76) Inventors: Hartmut Weik, Stuttgart (DE); Lothar Krank, Ditzingen (DE); Wolfgang Lautenschlager, Weissach-Flacht (DE); Uwe Stahl, Leonberg (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/785,492

(22) Filed: Feb. 20, 2001

(30) Foreign Application Priority Data
Feb. 28, 2000 (DE) 100 09 279.9

(51) Int. Cl. G10L 11/00

(52) U.S. Cl. 704/270.1

(57) ABSTRACT

The invention relates to a method for setting up a communication connection via an Internet Protocol (IP) network (3) from a first terminal (4) of a telecommunications network (2) to a second terminal (6) of an IP subscriber (5). To facilitate the setup of the communication connection via the IP network (3) even from conventional telephones (4) and thereby achieve the maximum possible spread of IP telephony, it is proposed that

the setup of the communication connection is coordinated by a server (10);

a target address of the second terminal (6) is entered via the first terminal (4) in voice format;

the target address is converted by means of voice recognition from voice format to an IP-compatible format; and

the server (10) causes the communication connection to be set up from the first terminal (4) to the second terminal (6) with the aid of the target address in IP-compatible format.

The present invention relates to a method for setting up a communication connection via an Internet Protocol (IP) network from a first terminal of a telecommunications network to a second terminal of an IP subscriber. The invention also relates to a server for setting up a communication connection via an Internet Protocol (IP) network from a first terminal of a telecommunications network to a second terminal of an IP subscriber. Finally, the invention relates to an intelligent network with a server, which has access to an exchange of a subordinate telecommunications network.

The present invention relates to the field of telephony via data networks, in particular the field of telephony via Internet Protocol (IP) networks, so-called Internet telephony.

It is known from the prior art to use IP networks (e.g. the Internet or intranet) for telephony. A wide spread is being predicted for the future for Internet telephony, which is also described as Voice-over-Internet-Protocol (VoIP), as it facilitates substantial cost savings compared with conventional telephone connections via the telephone network, particularly for long-distance calls and calls to abroad. For the VoIP, both the caller and the call partner must have terminals with Internet access. To be able to make a call via an IP network, both terminals must be connected to the Internet. Connection of the terminals to the Internet can be set up via the telephone network at the local rate. The actually large and, in the case of a conventional call connection via the telephone network, very expensive distance between the caller and the call partner is managed via the normally very economical IP network.

There are various methods of implementing VoIP. One basic difference in the methods consists in the type of terminals used. Personal Computers (PCs) with a multimedia capability are often used here, on which computers suitable software is installed for sending voice data via the IP network. Telephony from PC to PC is thereby possible via the IP network.

However, in telephony from PC to PC, the circle of users is severely limited, as a large number of potential users of Internet telephony have no PC or no suitably equipped PC. For this reason, some suppliers of Internet telephony offer solutions in which a transition is realized from the conventional telephone network to an IP network using so-called gateways. Due to this, VoIP is possible between a conventional telephone (analogue or ISDN) and a PC or even between two telephones, although to enter the target address of a subscriber who only has an IP address a specially equipped telephone is required. The telephone must have at least the possibility of inputting alphanumeric characters. One such input option is for example a suitably configured numeric keypad, on which various alphanumeric characters can be produced by repeated actuation of a key, or a separate alphanumeric keypad. According to the prior art, Internet telephony can thus not be performed from a conventional telephone, which has only a simple numeric keypad or even a dial.

The object of the present invention is to facilitate the setup of a communication connection even from conventional telephones via an IP network to an IP subscriber, in order thus to achieve the maximum possible spread of Internet telephony.

To achieve this object, the invention proposes, starting out from the method of the type specified at the beginning, that

a call number, which effects the transfer of the connection setup to a server, is dialled from the first terminal;

the server causes a voice connection to be set up from the first terminal to a voice recognition unit;

a target address of the second terminal is entered in voice format via the first terminal;

the target address is converted by means of voice recognition from the voice format to an IP-compatible format; and

the server causes the communication connection from the first terminal to the second terminal to be set up via a gateway with the aid of the target address in IP-compatible format.

The first terminal is preferably formed as a telephone. From the telephone, a call number is dialled, which effects the transfer of the connection setup to a server. With reference to the call number dialled and other connection parameters (origin of the call, date, time etc.) the server recognizes that a target address of an Internet Protocol (IP) subscriber is supposed to be entered in voice format and causes a voice connection to be set up from the first terminal to a voice recognition unit.

The target address of the desired subscriber is then entered via the first terminal in voice format and forwarded via the voice connection to the voice recognition unit. The target address is an electronic mail (e-mail) address (e.g. email@subscriber.de), for example, an Internet Protocol (IP) address (address of a server in the IP network; e.g. 149.257.629.430) or the address of a homepage of the subscriber in the IP network (address of a file on a server in the IP network; e.g. http://www.subscriber.de). The voice recognition unit is either formed as an independent unit or integrated into the server. To enter the target address—optionally at the invitation of the voice recognition unit—the target address of the IP subscriber is quite simply spoken into the telephone by the caller.

The voice recognition unit then converts the target address from voice format to an IP-compatible format. Finally, the server, with the aid of the target address in IP-compatible format, causes the communication connection to be set up from the first terminal to the second terminal of the IP subscriber via the telecommunications network, the gateway and the IP network.

The method according to the invention makes it possible for telephone users who only have a conventional telephone with a dial or simple numerical keypad to enter a target address of an IP subscriber without additional devices and make Voice-over-Internet-Protocol (VoIP) calls for the first time.

According to an advantageous further development of the present invention, it is proposed that the call number is received and transmitted for connection setup to the server by an exchange which is connected to the server. So that dialling of a certain call number by the first terminal effects transfer of the connection setup to the server, the call number is accordingly marked recognizably for the exchange. The connection between the exchange and the server is implemented in a packet-oriented, thus not line-oriented, manner.

According to a preferred embodiment of the present invention, it is proposed that the target address of the second terminal is conveyed by the first terminal via the exchange to the voice recognition unit. The voice connection from the first terminal to the voice recognition unit goes therefore via the exchange. Following conversion of the target address to IP-compatible format, the target address is conveyed via a packet-oriented connection from the voice recognition unit to the server.

From the server the target address is then conveyed according to a further preferred embodiment of the invention in IP-compatible format to the gateway, which sets up a Voice-over-Internet-Protocol (VoIP) connection to the second terminal via the IP network. The connection between server and gateway is packet-oriented.

Alternatively, it is proposed that the target address is conveyed from the server via the exchange to the gateway. The connection between the server and the exchange and between the exchange and the gateway is packet-oriented.

Finally, it is proposed that to set up the communication connection, the server causes the exchange to disconnect the voice connection from the first terminal to the voice recognition unit and convey it via a further voice connection to the gateway, where it is connected to the VoIP connection. The further voice connection extends from the exchange to the gateway.

As a further way of achieving the object of the present invention, it is proposed starting out from the server of the type specified at the beginning that

the server has access to a voice recognition unit;

the voice recognition unit converts a target address of the second terminal entered via the first terminal from a voice format to an IP-compatible format by means of voice recognition; and

the server causes the communication connection to be set up from the first terminal to the second terminal via a gateway with the aid of the target address in IP-compatible format.

According to an advantageous further development of the invention, it is proposed that the server is connected to an exchange of the telecommunications network, which exchange sets up the communication connection at the instigation of the server.

The voice recognition unit can be formed as a separate unit. According to a preferred embodiment of the invention, however, it is proposed that the voice recognition unit is an integral part of the server. Alternatively, it is proposed that the voice recognition unit is an integral part of the exchange.

According to another advantageous further development of the present invention, it is proposed that the server and the voice recognition unit are part of an intelligent network. For this purpose, the server is formed as a so-called Service Control Point (SCP). The exchange of the telecommunications network is formed as a so-called Service Switching Point (SSP). The voice recognition unit is implemented for example at a so-called Specialized Resource Point (SRP) of the intelligent network.

As a further means of achieving the object of the present invention, it is proposed starting out from the intelligent network of the type specified at the beginning that the server has access to a voice recognition unit, which converts a target address of the second terminal entered via the first terminal from voice format to IP-compatible format by means of voice recognition.

A preferred practical example of the present invention is explained in greater detail below with reference to the drawing.

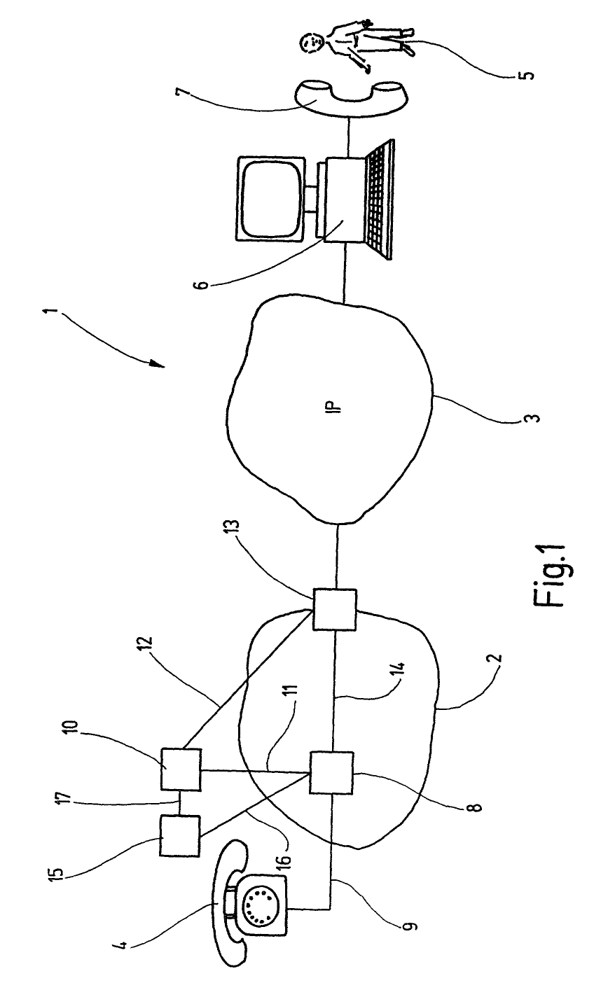

FIG. 1 shows: a heterogeneous network structure, in which the method according to the invention can be implemented.

In FIG. 1, a heterogeneous network structure in its totality is indicated by the reference character 1. It comprises a telecommunications network formed as a telephone network 2 and an Internet Protocol (IP) network 3, which in the present practical example is formed as the Internet. The telephone network 2 is formed as a digital telephone network (e.g. Integrated Services Digital Network, ISDN) or as an analogue telephone network (e.g. Public Switched Telephone Network, PSTN).

A first terminal formed as a conventional telephone 4 is connected to the telephone network 2. A transition from the conventional telephone network 2 to the IP network 3 is realized by means of a gateway 13. An Internet Protocol (IP) subscriber 5 has access to the IP network 3 via a second terminal formed as a computer 6. The computer 6 has suitable means 7 for inputting and outputting speech. The means 7 are shown only symbolically in FIG. 1. The means 7 are actually formed for example as headphones with a microphone attached thereto, which is positioned in front of the mouth of the subscriber 5. The means 7 are connected for example to a sound card output (not shown) of the computer 6. The computer 6 can access the IP network 3 via a modem (not shown) or an ISDN card (not shown) via a gateway (not shown).

To be able to set up a communication connection in the context of IP telephony—the so-called Voice over Internet Protocol (VoIP)—from the telephone 4 via the IP network 3 to a computer 6, the target address at which the computer 6 can be reached must first be entered from the telephone 4. The target address is an electronic mail (e-mail) address, for example (e.g. email@subscriber.de), an Internet protocol (IP) address (address of a server in the IP network; e.g. 149.257.629.430) or the address of a homepage of the subscriber in the IP network 3 (address of a file on a server in the IP network; e.g. http://www.subscriber.de).

To enter the target address, this is spoken into the telephone 4, converted by a voice recognition unit from voice format to an IP-compatible format and then the communication connection is set up via the heterogeneous network structure.

An exchange 8 (so-called Service Switching Point, SSP) is disposed according to the invention between the telephone 4 and the gateway 13 to the IP network 3. The exchange 8 is connected to a server 10 (so-called Service Control Point, SCP) (connection 11). The connection 11 is formed as a packet-oriented connection. The server 10 is connected to a so-called Specialized Resource Point (SRP) 15 (connection 17). Formed at the SRP is the voice recognition unit 15. The voice recognition unit 15 can be formed as a separate unit or as a physical unit with the server 10 or the exchange 8. The connection 17 is formed as a packet-oriented connection. The exchange 8 is connected via a line-oriented connection 16 to the voice recognition unit 15. Finally, the server 10 is connected via a packet-oriented connection 12 to the gateway 13. The server 10 and the voice recognition unit 15 are part of a so-called intelligent network ranking above the telephone network 2.

A call number is first dialled from the telephone 4, which number effects transfer of the connection setup to a server. The exchange 8 recognizes the call number dialled and transfers the connection setup to a server 10. With reference to the call number dialled and other connection parameters (e.g. origin of the call, date, time etc.), the server 10 recognizes that a target address of the computer 6 is supposed to be entered in voice format and causes a voice connection 9, 16 to be set up from the telephone 4 to the voice recognition unit 15.

The target address of the computer 6 of the desired subscriber 5 is then entered via the telephone 4 in voice format and forwarded via the voice connection 9, 16 to the voice recognition unit 15. The voice recognition unit 15 then converts the target address from voice format to an IP-compatible format. Finally, the server 10 with the aid of the target address in IP-compatible format causes the communication connection from the telephone 4 to the computer 6 of the IP subscriber 5 to be set up via the telephone network 2, the gateway 13 and the IP network 3.

To set the communication connection up, the target address in IP-compatible format is forwarded via the connection 12 to the gateway 13, which sets a VoIP connection to the computer 6 up via the IP network 3. The server 10 then disconnects the voice connection 16 from the voice recognition unit 10 and conveys the voice connection 9 via the voice connection 14 to the gateway 13, where it is connected to the VoIP connection. A caller from the telephone 4 can then make a call to the subscriber 5 via the communication connection.

1. Method of setting up a communication connection via an Internet Protocol (IP) network from a first terminal of a telecommunications network to a second terminal of an IP subscriber, characterized in that
a call number, which effects transfer of the connection setup to a server, is dialled from the first terminal;
the server causes a voice connection to be set up from the first terminal to a voice recognition unit;
a target address of the second terminal is entered in voice format via the first terminal;
the target address is converted by means of voice recognition from voice format to an IP-compatible format; and
the server causes the communication connection to be set up from the first terminal to the second terminal via a gateway with the aid of the target address in IP-compatible format.

2. Method according to claim 1, characterized in that the call number is received by an exchange, which is connected to the server, and is transmitted to the server to set up the connection.

3. Method according to claim 2, characterized in that the target address of the second terminal is conveyed from the first terminal via the exchange to the voice recognition unit.

4. Method according to claim 2 or 3, characterized in that the target address is conveyed in IP-compatible format by the server to the gateway, which sets up a Voice-over-Internet-Protocol (VoIP) connection to the second terminal via the IP network.

5. Method according to claim 4, characterized in that the target address is conveyed by the server via the exchange to the gateway.

6. Method according to claim 4 or 5, characterized in that the server causes the exchange to disconnect the voice connection from the first terminal to the voice recognition unit and convey it via a further voice connection to the gateway, where it is connected to the VoIP connection.

7. Server for coordinating the setup of a communication connection via an Internet Protocol (IP) network from a first terminal of a telecommunications network to a second terminal of an IP subscriber, characterized in that
the server has access to a voice recognition unit;
the voice recognition unit converts a target address of the second terminal entered via the first terminal from a voice format to an IP-compatible format by means of voice recognition; and
the server causes the communication connection to be set up from the first terminal to the second terminal via a gateway with the aid of the target address in IP-compatible format.

8. Server according to claim 7, characterized in that the voice recognition unit is an integral part of the server.

9. Server according to claim 7 or 8, characterized in that the server is connected to an exchange of the telecommunications network, which exchange sets up the communication connection at the instigation of the server.

10. Server according to claim 9, characterized in that the voice recognition unit is an integral part of the exchange.

11. Server according to claim 7, characterized in that the server and the voice recognition unit are part of an intelligent network.

12. Intelligent network with a server, which has access to an exchange of a subordinate telecommunications network, in particular to implement the method according to one of the preceding claims, characterized in that the server has access to a voice recognition unit, which converts a target address of the second terminal entered via the first terminal from a voice format to an IP-compatible format by means of voice recognition.
